(19) United States
(12) Patent Application Publication
(10) Pub. No.: US 2016/0358726 A1
(43) Pub. Date: Dec. 8, 2016

(54) SWITCH

(71) Applicant: Satori S-Tech Co., Ltd., Tokyo (JP)

(72) Inventor: Masaaki SAITO, Tokyo (JP)

(73) Assignee: Satori S-Tech Co., Ltd., Tokyo (JP)

(21) Appl. No.: 15/170,015

(22) Filed: Jun. 1, 2016

(30) Foreign Application Priority Data
Jun. 4, 2015 (JP) 2015-113830
Jun. 4, 2015 (JP) 2015-113832

(51) Int. Cl. H01H 15/18; B25F 5/02

(52) U.S. Cl. CPC H01H 15/18; B25F 5/02; H01H 2300/048; H01H 2235/01

(57) ABSTRACT

An actuator is allowed to move toward +A direction and toward −A direction. A movable contact engages with the actuator. A fixed contact touch the movable contact with electrical connection when the movable contact is located at an ON position, and are apart from the movable contact with electrical isolation when the movable contact is located at positions other than the ON position. An arc prevention mechanism prevents arc between the movable contact and the fixed contact.

Priority is claimed on Japanese Patent Applications Nos. 2015-113830 and 2015-113832, which are filed on Jun. 4, 2015, and the content of which is incorporated herein by reference.

### TECHNICAL FIELD

The present invention is related to a switch such as a trigger switch used in a electric power tool or the like.

### BACKGROUND ART

In order to prevent generation of arc in switching, there is known a quick movement mechanism accumulating energy in a helical compression spring and instantly releasing it, so as to rapidly move a movable contact.

For example, JP 56-57439 U discloses a slide switch provided with two helical compression springs at two sides of a contact holder. The slide switch realizes quick movement by accumulating energy in one of the helical compression springs, when the switch is being turned on. When the switch is being turned off, quick movement is realized by accumulating energy in the other of the helical compression springs, because force is required to be acted toward a direction opposite that in the switching-on case.

Also, the document discloses another slide switch provided with two protrusions at two sides of a helical compression spring accommodated in a spring supporting member. The slide switch accumulates energy by compressing the helical compression spring between one of the protrusions and the spring supporting member, when the switch is being turned on. When the switch is being turned off, force is acted toward the direction opposite that in the switching-on case, by compressing the helical compression spring between the other of the protrusions and the spring supporting member to accumulate energy.

JP 2002-521800 A discloses a slide switch provided with extension parts at two sides of a second spring accommodated in a receptacle. The slide switch accumulates energy by compressing the second spring between one of the extension parts and the receptacle in the switching-on case. In the switching-off case, force is acted toward the direction opposite that in the switching-on case, by compressing the second spring between the other of the extension parts and the receptacle to accumulate energy.

There is also known a switch restraining a movable contact from bouncing in order to prevent generation of arc in switching.

JP 2006-218560 A discloses a trigger switch for flowing regeneration current to brake a motor, by means of shorting between ends of the motor or the like, in order to stop continuous rotation of the motor caused by inertia when the switch of the motor is turned off. The trigger switch prevents bouncing by biasing the movable contact by using a contact supporting spring in a switching-on case. In a switching-off case, bouncing is prevented by biasing a sliding frame including the movable contact by a sliding frame spring toward a direction opposite that in a switching-on case.

### SUMMARY OF INVENTION

### Technical Problem

Miniaturization of an electric power tool requires to downsize a trigger switch. Secure prevention of arc requires to accumulate as large energy as possible in the helical compression spring to move the movable contact as rapidly as possible. This hinders the helical compression spring from being so shortened.

The configuration where the helical compression springs are provided at the two sides of the contact holder, makes an operation member long in a movement direction. This makes it difficult to downsize the trigger switch.

The configuration where the spring supporting member, or the receptacle, accommodates the helical compression spring, or the second spring, and the helical compression spring is compressed between it and the protrusion, or the extension part, makes the operation member, or a sliding member, shorter in the movement direction, because the number of the helical compression springs decreases to one. However, it is required to provide spaces, where the protrusions move against the spring supporting member, at the two sides of the helical compression spring. This elongates the operation member in the movement direction, and thereby makes it difficult to downsize the trigger switch.

The configuration where the two springs bias the movable contact, elongates an assembly including the movable contact in the movement direction. This makes it difficult to downsize the trigger switch.

The present invention aims to downsize a switch with secure prevention of arc.

### Solution to Problem

A switch according to the present invention includes: an actuator, allowed to move toward an ON direction and toward an OFF direction opposite the ON direction; a movable contact, engaging with the actuator; a fixed contact, configured to touch the movable contact with electrical connection when the movable contact is located at an ON position, and to be apart from the movable contact with electrical isolation when the movable contact is located at positions other than the ON position; and an arc prevention mechanism, configured to prevent generation of arc between the movable contact and the fixed contact.

The switch may further include a plunger, allowed to move toward the ON direction and toward the OFF direction.

The actuator may engage with the plunger to be allowed to move toward the ON direction and toward the OFF direction against the plunger.

The arc prevention mechanism may include: a quick ON spring, composed of a helical compression spring to bias the actuator toward the ON direction against the plunger; a quick OFF spring, composed of a helical compression spring to bias the actuator toward the OFF direction against the plunger; and a restriction mechanism, configured to restrict movement of the actuator before the actuator passes over a switching position, and to release the actuator after the actuator passes over the switching position.

The plunger may include: a quick ON spring accommodation part, accommodating the quick ON spring; a quick ON projection accommodation part, disposed in the ON direction against the quick ON spring accommodation part; a quick OFF spring accommodation part, disposed in a direction different from the ON direction and the OFF direction against the quick ON spring accommodation part, and accommodating the quick OFF spring; and a quick OFF projection accommodation part, disposed in the OFF direction against the quick OFF spring accommodation part.

The actuator may include: a quick ON projection, accommodated in the quick ON projection accommodation part with being allowed to move toward the ON direction and the OFF direction, and biased toward the ON direction by the quick ON spring; and a quick OFF projection, accommodated in the quick OFF projection accommodation part with being allowed to move toward the ON direction and the OFF direction, and biased toward the OFF direction by the quick OFF spring.

The quick ON projection may be a protrusion protruding toward a direction different from the ON direction and the OFF direction, and may have a roughly rectangular parallelepiped shape, a width smaller than a diameter of the quick ON spring, and a height larger than the diameter of the quick ON spring.

The quick OFF projection may be a protrusion protruding toward a direction different from the ON direction and the OFF direction, and may have a roughly rectangular parallelepiped shape, a width smaller than a diameter of the quick OFF spring, and a height larger than the diameter of the quick OFF spring.

The quick ON projection accommodation part may be a concavity with an opening in a direction opposite the direction toward which the quick ON projection protrudes, and may have a width smaller than the diameter of the quick ON spring.

The quick OFF projection accommodation part may be a concavity with an opening in a direction opposite the direction toward which the quick OFF projection protrudes, and may have a width smaller than the diameter of the quick OFF spring.

The quick ON spring accommodation part may be a concavity with an opening in a direction roughly the same as the direction of the opening of the quick ON projection accommodation part, may have a depth roughly the same as that of the quick ON projection accommodation part, and may include: quick ON spring accommodation inner wall faces, having a distance between them roughly the same as the diameter of the quick ON spring; quick ON spring supporting inner wall faces, continuously extending inward from the quick ON spring accommodation inner wall faces, and curving along an outer periphery of the quick ON spring with a roughly circular column shape; and quick ON projection reception inner wall faces, continuously extending further inward from the quick ON spring accommodation inner wall faces, and having a distance between them roughly the same as the width of the quick ON projection accommodation part.

The quick OFF spring accommodation part may be a concavity with an opening in a direction roughly the same as the direction of the opening of the quick OFF projection accommodation part, may have a depth roughly the same as that of the quick OFF projection accommodation part, and may include: quick OFF spring accommodation inner wall faces, having a distance between them roughly the same as the diameter of the quick OFF spring; quick OFF spring supporting inner wall faces, continuously extending inward from the quick OFF spring accommodation inner wall faces, and curving along an outer periphery of the quick OFF spring with a roughly circular column shape; and quick OFF projection reception inner wall faces, continuously extending further inward from the quick OFF spring accommodation inner wall faces, and having a distance between them roughly the same as the width of the quick OFF projection accommodation part.

The actuator may include: a quick ON spring supporting part, being a protrusion disposed in the OFF direction against the quick ON projection, protruding toward a direction roughly the same as the direction toward which the quick ON projection protrudes, and having a width roughly the same as the width of the quick ON projection, and an upper face recessed along the outer periphery of the quick ON spring with a roughly circular cylindrical shape; and a quick OFF spring supporting part, being a protrusion disposed in the ON direction against the quick OFF projection, protruding toward a direction roughly the same as the direction toward which the quick OFF projection protrudes, and having a width roughly the same as the width of the quick OFF projection, and an upper face recessed along the outer periphery of the quick OFF spring with a roughly circular cylindrical shape.

The switch may further include: a second fixed contact, configured to touch the movable contact to be electrically connected with the fixed contact via the movable contact when the movable contact is located at the ON position, and to be apart from the movable contact to be electrically isolated from the movable contact and the fixed contact when the movable contact is located at positions other than the ON position; an OFF fixed contact, configured to touch the movable contact with electrical connection when the movable contact is located at an OFF position in the OFF direction against the ON position, and to be apart from the movable contact with electrical isolation when the movable contact is located at positions other than the OFF position; and a second OFF fixed contact, configured to touch the movable contact to be electrically connected with the OFF fixed contact via the movable contact when the movable contact is located at the OFF position, and to be apart from the movable contact to be electrically isolated from the movable contact and the OFF fixed contact when the movable contact is located at positions other than the OFF position.

The arc prevention mechanism may include a holding spring, composed of a helical compression spring, biasing the movable contact toward the ON direction against the actuator, to hold the movable contact in the ON position when the actuator is located in the ON direction of the switching position.

The actuator may include an actuator plate, intervening between the fixed contact and the second fixed contact and between the OFF fixed contact and the second OFF fixed contact,

The actuator plate may include: a holding spring accommodation part, accommodating the holding spring; and a penetrating hole, disposed in the ON direction against the holding spring accommodation part, the movable contact inserted through the penetrating hole.

The movable contact may be allowed to swing around a fulcrum in the ON direction against the holding spring when the movable contact touches an inner wall face in the ON direction of the penetrating hole by being biased by the holding spring.

The penetrating hole may include a ridge part, swollen toward the OFF direction from the inner wall face in the ON direction, and functioning as the fulcrum of the swing of the movable contact.

### Advantageous Effects of Invention

According to the present invention, the arc prevention mechanism preventing generation of arc enables to downsize the switch.

A quick OFF mechanism, such as the quick OFF spring and the quick OFF projection, disposed the direction different from the ON direction and the OFF direction against a quick ON mechanism, such as the quick ON spring and the quick ON projection, enables to shorten a length of the whole of the quick movement mechanism including the quick ON mechanism and the quick OFF mechanism. This achieves secure prevention of generation of arc, as well as downsizing of the trigger switch.

The quick ON and quick OFF spring supporting parts of the quick ON and quick OFF spring accommodation parts supporting the quick ON and quick OFF springs, the height of the quick ON and quick OFF projections greater than the diameter of the quick ON and quick OFF spring, and spaces, for receiving the quick ON and quick OFF projections, provided on a bottom of the quick ON and quick OFF spring accommodation parts enable to securely hold the quick ON and quick OFF springs, as well as enable ends of the quick ON and quick OFF projections to touch ends of the quick ON and quick OFF springs at two areas. This realizes biasing force by the quick ON and quick OFF springs to act straightly toward the ON direction and the OFF direction. This enables the quick ON and quick OFF mechanisms to securely work without the quick ON and quick OFF mechanisms disposed on a central axis of the trigger switch.

The quick ON and quick OFF spring supporting parts provided on the actuator enable to securely hold the quick ON and quick OFF springs. This achieves more secure function of the quick ON and quick OFF mechanisms.

The holding spring biasing the movable contact toward the ON direction and pressing it against the ON fixed contacts enables to prevent bouncing and also generation of arc in the switching-on case. The movable contact allowed to swing around a fulcrum in the ON direction against the holding spring enables to absorb a difference between positions of the two OFF fixed contact by swinging of the movable contact in the switching-off case. This achieves to prevent bouncing and also generation of arc. The switch can be downsized because no spring for biasing the movable contact toward the OFF direction is required.

The ridge part swollen toward the OFF direction from the inner wall face in the ON direction of the penetrating hole enables easily to allow the movable contact to swing. This achieves to securely prevent generation of arc, and to downsize the switch.

### BRIEF DESCRIPTION OF DRAWINGS

FIG. 1 shows a right side view of appearance of a trigger switch;

FIG. 2 shows a right side view of the trigger switch without a packing and a cover;

FIG. 3 shows side views of inside of a case body and the cover;

FIG. 4 shows a plan view, a front view, a right side view, a back view and a bottom view of a plunger;

FIG. 5 shows an expanded sectional front view along V-V line of the plunger;

FIG. 6 shows an expanded sectional front view along VI-VI line of the plunger;

FIG. 7 shows a plan view, a left side view, a front view, a right side view, a back view and a bottom view of an actuator without a sliding part;

FIG. 8 shows a plan view, a left side view, a front view, a right side view, a back view and a bottom view of the sliding part;

FIG. 9 shows a plan view, a front view and a right side view of a actuator tip;

FIG. 10 shows an expanded front view of a quick ON projection and a quick OFF projection;

FIG. 11 shows an expanded sectional plan view of an actuator plate;

FIG. 12 shows a plan view, a left side view, a front view, a right side view, a back view and a bottom view of an ON terminal or an OFF terminal;

FIG. 13 shows a plan view, a left side view, a front view, a right side view and a bottom view of a common terminal;

FIG. 14 shows a plan view, a left side view, a front view and a right side view of a connection metal;

FIG. 15 shows a plan view, a front view and a right side view of a movable contact;

FIG. 16 shows a sectional plan view of operation of the trigger switch;

FIG. 17 shows a sectional plan view of a principle of prevention of rebounding; and

FIG. 18 shows a plan view, a left side view, a front view, a right side view, a back view and a bottom view of another sliding part.

### DESCRIPTION OF EMBODIMENT

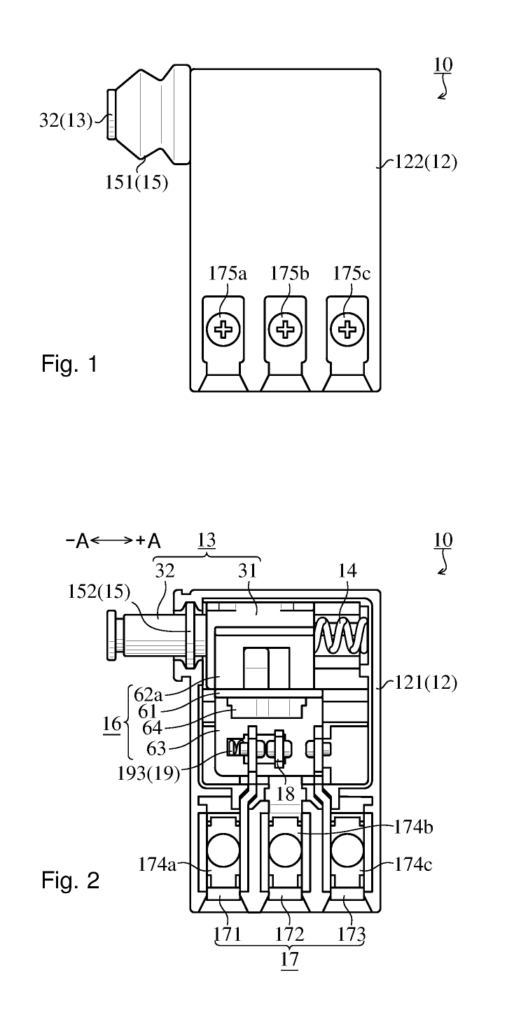

A trigger switch 10 shown in FIG. 1 is a switch mounted in a electric power tool or the like, for turning a rotation of a motor on and off.

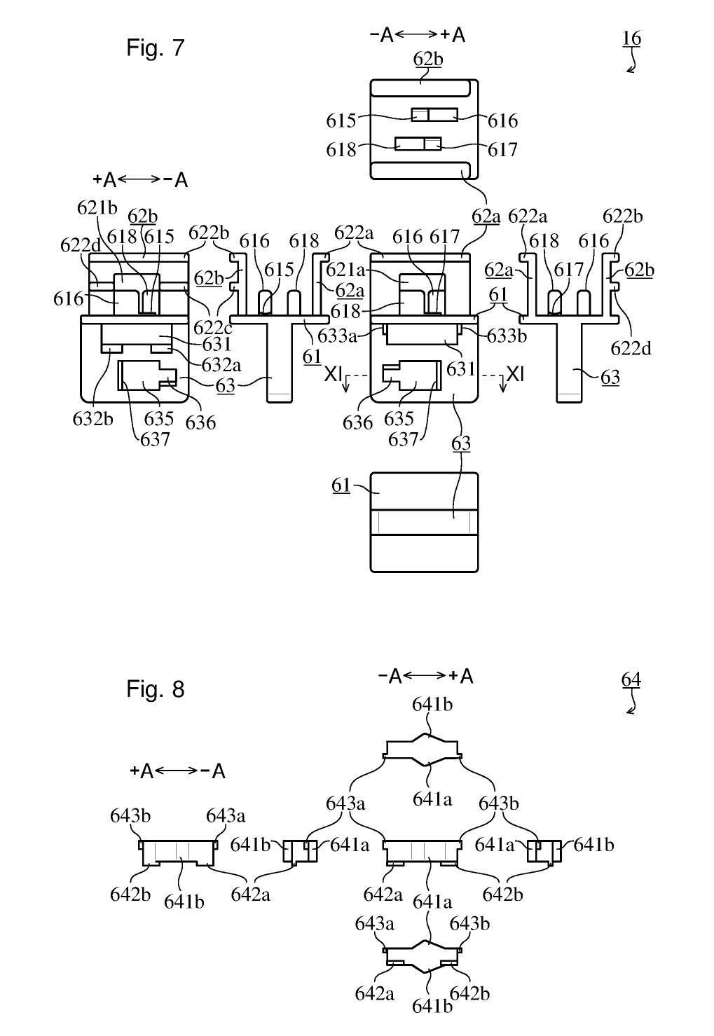

As shown in FIG. 2, the trigger switch 10 includes the followings.
(1) A case 12. It has a roughly rectangular parallelepiped box shape, and is formed by fitting a case body 121 and a cover 122, shown in FIG. 1.
(2) A plunger 13. It includes a plunger body 31 with a roughly rectangular parallelepiped shape, and an operation part 32 with a roughly circular column shape. The plunger body 31 is disposed in the case 12. The operation part 32 is exposed outside the case 12. When an user pulls a trigger of the electric power tool, the operation part 32 is pushed toward +A direction, or an ON direction, the whole of the plunger 13 moves toward +A direction.
(3) A return spring 14. It is composed of a helical compression spring, disposed between the case 12 and the plunger 13 to bias the plunger 13 against the case 12 toward −A direction, or an OFF direction, which is a direction opposite the +A direction. When the user releases the trigger of the electric power tool, or weakens a force of pulling the trigger, a force of the return spring 14 moves the plunger 13 toward −A direction.
(4) A dustproof mechanism 15. It is composed of a packing 151, shown in FIG. 1, a sponge 152 or the like, for example. It prevents dust, water or the like from invading the interior of the case 12 through an opening for exposing the operation part 32 of the plunger 13 outside the case 12.
(5) An actuator 16. It includes:
   an actuator body 61, with a roughly flat plate shape and disposed along a bottom face of the plunger body 31;
   actuator upper parts 62a and 62b, shown in FIG. 7, with roughly rectangular frame shapes and protruding upward from the actuator body 61;
   an actuator plate 63, with a roughly flat plate shape and protruding downward from the actuator body 61; and
   a sliding part 64, press-fitted to the actuator plate 63.

The actuator upper parts 62a and 62b engage with the plunger body 31. The whole of the actuator 16 moves toward ±A directions, accompanying movement of the plunger 13, with being allowed to relatively move within a predetermined span in ±A directions against the plunger 13.
(6) A terminal part 17. It includes:
   an OFF terminal 171, a common terminal 172 and an ON terminal 173, which are fixed to the case 12;
   connection metals 174a to 174c, engaging with these terminals 171 to 173; and
   connection screws 175a to 175c, shown in FIG. 1, screwed to the case 12.

It is used for being connected with wires connected to an electric power source, the motor or the like. The wires are inserted between the terminals 171 to 173 and the connection metals 174a to 174c, and then the connection screws 175a to 175c are tightened. Thereby, the wires are fixed and electrically connected to the terminals 171 to 173.
(7) A movable contact 18. It engages with the actuator 16, and moves toward ±A directions, accompanying movement of the actuator 16, with being allowed to relatively move within a predetermined span in ±A directions against the actuator 16. The movable contact 18 moves between an OFF position and an ON position. When located at the OFF position, it bridges between the OFF terminal 171 and the common terminal 172. When located at the ON position, it bridges between the ON terminal 173 and the common terminal 172.

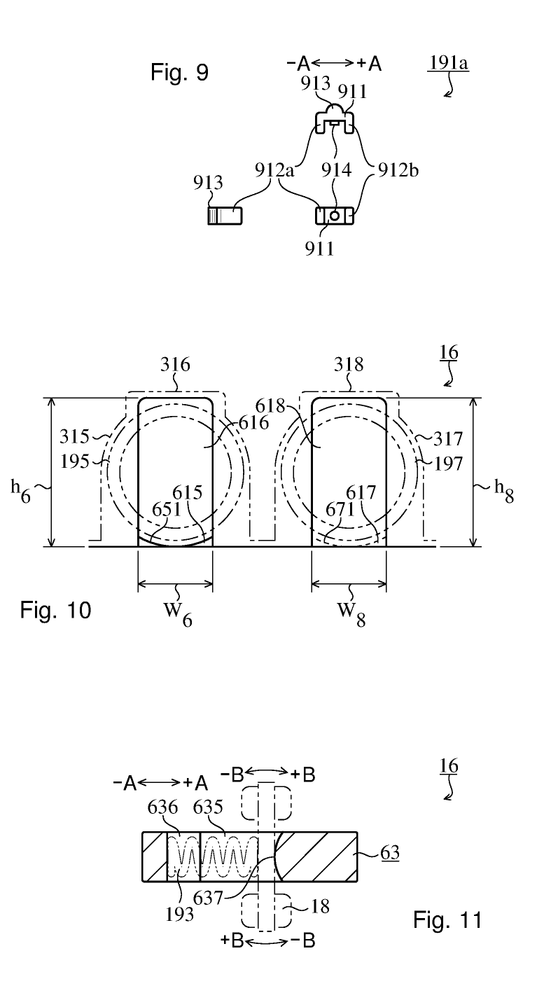

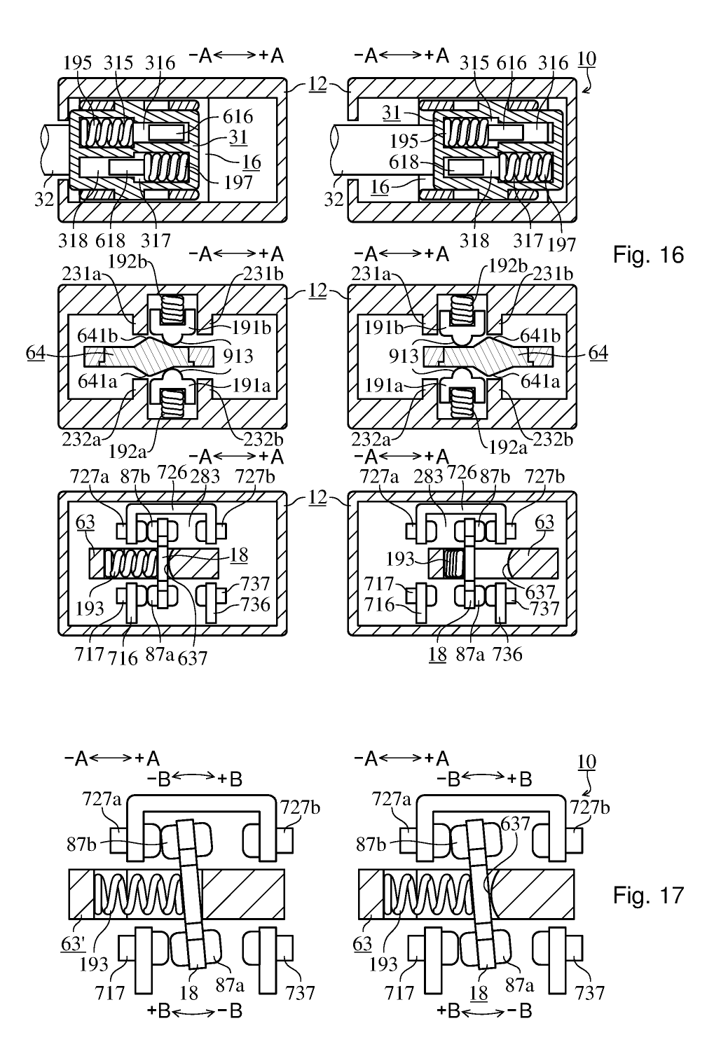

The electric power tool having the trigger switch 10 is configured to supply electric current from the electric power source to the motor so as to rotate the motor when the ON terminal 173 and the common terminal 172 are bridged. When the OFF terminal 171 and the common terminal 172 are bridged, two ends of the motor are shorted, so as to flow regeneration current, to brake the rotation of the motor, and to promptly stop the rotation of the motor. And,
(8) A quick movement mechanism 19. It includes, for example, actuator tips 191a and 191b, shown in FIG. 9, restriction springs 192a and 192b, shown in FIG. 16, a holding spring 193, a quick ON spring 195, shown in FIG. 16, a quick OFF spring 197, show in FIG. 16, and the like. It forces the movable contact 18 to rapidly move from the OFF position to the ON position when the plunger 13 moves toward +A direction and passes over a predetermined position. It also forces the movable contact 18 to rapidly move from the ON position to the OFF position when the plunger 13 moves toward −A direction and passes over a predetermined position.

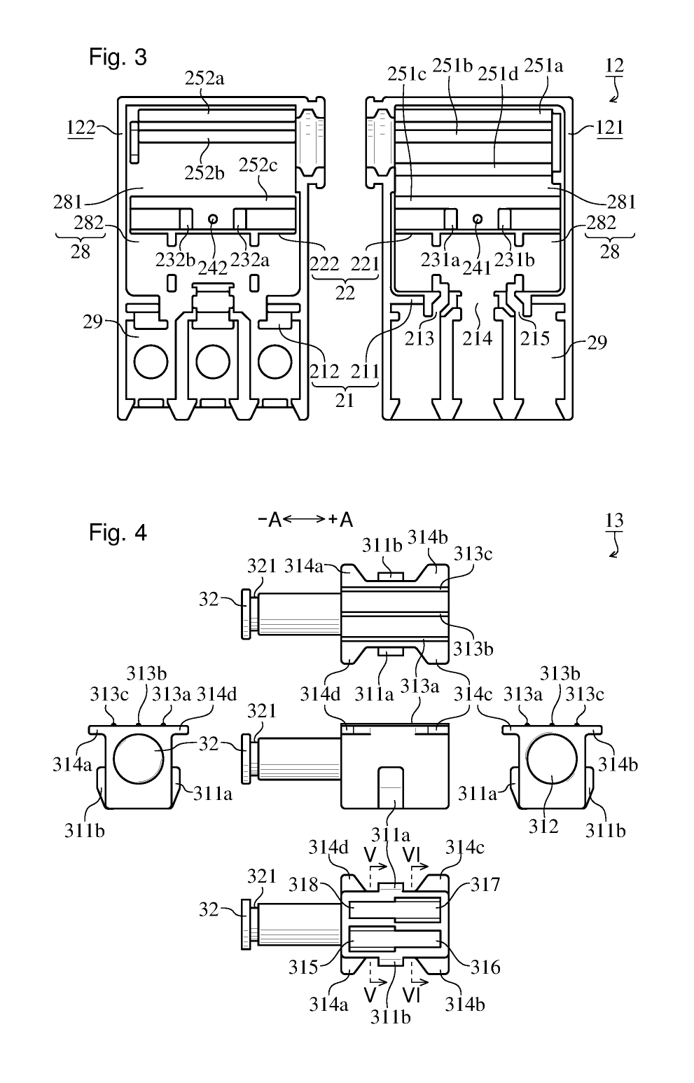

As shown in FIG. 3, the case 12 includes the followings.
(1) A partition 21. It is formed by combining a partition part 211 of the case body 121 and a partition part 212 of the cover 122. It separates inside of the case 12 into a switch room 28 and a wire room 29. The partition parts 211 and 212 protrude inward from left and right side walls of the case 12. The switch room 28 accommodates the plunger body 31 of the plunger 13, the actuator 16 and the like. The wire room 29 accommodates part of the terminal part 17, with which the wires are connected. The partition 21 has passages 213 to 215 through which the terminals 171 to 173 pass. In order to prevent dust or water from invading the switch room 28 through the passages 213 to 215, the passages 213 to 215 are formed with a labyrinth shape, instead of with a straight shape. Furthermore, the terminals 171 to 173 are press-fitted into the passages 213 to 215. This prevents generation of gaps between the terminals 171 to 173 and the passages 213 to 215.
(2) A partition 22. It is formed by a partition part 221 of the case body 121 and a partition part 222 of the cover 122. It separates the switch room 28 further into a plunger room 281 and a contact room 282. The partition part 221 and 222 protrude inward from the left and right side walls of the case 12, and face each other across a gap. The plunger room 281 accommodates the plunger body 31 of the plunger 13, the actuator body 61, the actuator upper parts 62a and 62b, and sliding part 64 of the actuator 16, and the like. The contact room 282 accommodates the movable contact 18 and the like. The actuator plate 63 of the actuator 16 passes through the gap between the partition parts 221 and 222, and extends from the plunger room 281 to the contact room 282
(3) Actuator tip supporting parts 231a, 231b, 232a and 232b. Each of them is a protrusion with a roughly rectangular parallelepiped shape, protruding inward from the left or right side walls of the case 12, and adjoining an upper side of the partition 22. They support the actuator tips 191a and 191b, shown in FIG. 9, of the quick movement mechanism 19 from ±A directions.
(4) Restriction spring supporting parts 241 and 242. Each of them is a protrusion with a roughly circular column shape, protruding inward from the left or right side walls of the case 12, and disposed between the actuator tip supporting part 231a and 231b, or between the actuator tip supporting part 232a and 232b. They support the restriction springs 192a and 192b, shown in FIG. 16, of the quick movement mechanism 19. And,
(5) guide grooves 251a to 251d and 252a to 252c. Each of them is a groove with a linear shape parallel to ±A directions, provided inside the left or right side walls of the case 12. They guide movement of the plunger 13 and the actuator 16 in ±A directions. The guide grooves 251a and 252a are disposed at an upper end of the plunger room 281. The guide grooves 251b and 252b are disposed below the guide grooves 251a and 252a. The guide grooves 251c and 252c are disposed just above the actuator tip supporting part 231a, 231b, 232a and 232b. The guide groove 251d is disposed between the guide grooves 251b and 251c. The cover 122 has no guide groove at a position corresponding to the guide groove 251d of the case body 121.

As shown in FIG. 4, the plunger 13 includes the followings.
(1) Engagement protrusions 311a and 311b. Each of them is a protrusion protruding from the side faces of the plunger body 31 near its lower side, toward left or right directions. They engage with engagement openings 621a and 621b, shown in FIG. 7, of the actuator 16.
(2) A return spring accommodation part 312. It is a concavity with roughly circular column shape, recessed from a rear face, or a face in +A direction, of the plunger body 31 toward −A direction. It accommodates the return spring 14.
(3) Slide projection strips 313a to 313c. Each of them is a linear protrusion roughly parallel to ±A directions, protruding upward from an upper face of the plunger body 31. They touch an inner face of an upper wall of the case 12 so as to reduce an surface where the upper face of the plunger body 31 touches the case 12. This reduces sliding friction along with movement of the plunger 13 to prevent abrasion of the upper face of the plunger body 31.
(4) Guide wings 314a to 314d. Each of them is a protrusion protruding from the side faces of the plunger body 31 at those upper ends toward the left or right directions. Those distal ends engage with the guide grooves 251a and 252a of the case 12 so as to guide movement of the plunger 13 toward ±A directions.
(5) A quick ON spring accommodation part 315. It is a concavity recessed upward from a lower face of the plunger body 31. It accommodates a quick ON spring 195, shown in FIG. 16, of the quick movement mechanism 19.
(6) A quick ON projection accommodation part 316. It is a concavity recessed upward from the lower face of the plunger body 31, disposed in +A direction against the quick ON spring accommodation part 315 communicating with it. It accommodates a quick ON projection 616, shown in FIG. 7, of the actuator 16.
(7) A quick OFF spring accommodation part 317. It is a concavity recessed upward from the lower face of the plunger body 31. It accommodates a quick OFF spring 197, shown in FIG. 16, of the quick movement mechanism 19. And,
(8) a quick OFF projection accommodation part 318. It is a concavity recessed upward from the lower face of the plunger body 31, disposed in −A direction against the quick OFF spring accommodation part 317 communicating with it. It accommodates a quick OFF projection 618, shown in FIG. 7, of the actuator 16.

The quick ON spring accommodation part 315 and the quick ON projection accommodation part 316 are disposed parallel to the quick OFF spring accommodation part 317 and the quick OFF projection accommodation part 318 in left and right directions. It is important that they are not disposed linearly in ±A directions. That is, the quick OFF spring accommodation part 317 is located in a direction different from ±A directions against the quick ON spring accommodation part 315. This makes a required length in ±A directions shorter. This enables to downsize the trigger switch 10. Especially, the shortest length of the trigger switch in ±A directions can be achieved, when the quick OFF projection accommodation part 318 is disposed right beside the quick ON spring accommodation part 315 and the quick OFF spring accommodation part 317 is disposed right beside the quick ON projection accommodation part 316, as shown in this example.

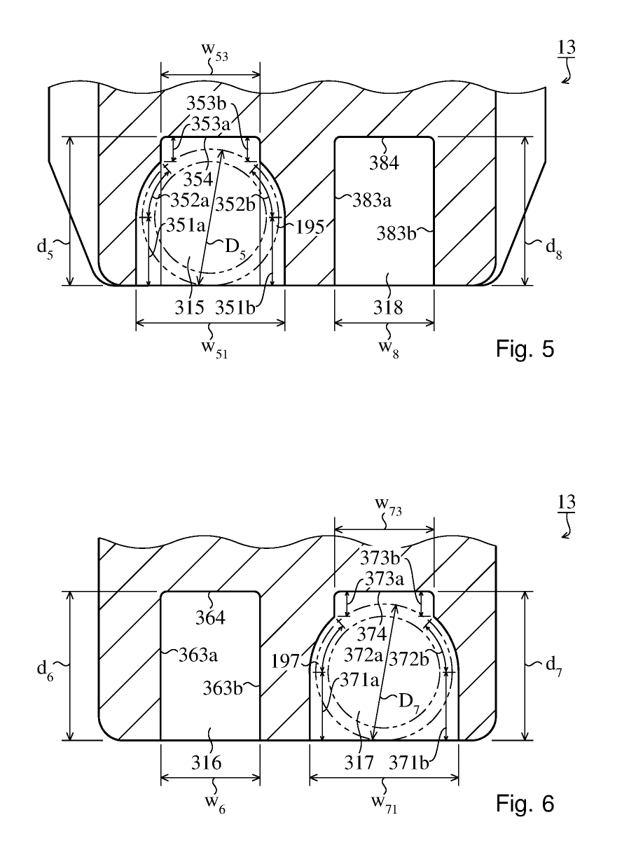

As shown in FIG. 5, the quick OFF projection accommodation part 318 has left and right inner wall faces 383a and 383b with flat planes roughly parallel to each other.

The quick ON spring accommodation part 315 has a depth d₅ greater than a diameter D₅ of the quick ON spring 195 accommodated in the quick ON spring accommodation part 315. The quick ON spring accommodation part 315 has left and right inner wall faces composed of quick ON spring accommodation inner wall faces 351a and 351b, quick ON spring supporting inner wall faces 352a and 352b, and quick ON projection reception inner wall faces 353a and 353b, continuously from the bottom in order. The quick ON spring accommodation inner wall faces 351a and 351b have flat planes roughly parallel to each other. A distance w₅₁ between them is slightly greater than the diameter D₅. The quick ON spring supporting inner wall faces 352a and 352b have recessed faces with circular column side face shapes bent along an outer periphery of the quick ON spring 195. Diameters of them are equal to the distance w₅₁. The quick ON projection reception inner wall faces 353a and 353b have flat planes roughly parallel to each other. A distance w₅₃ between them is less than the diameter D₅. Thereby, the quick ON spring 195 is supported and held by the quick ON spring supporting inner wall faces 352a and 352b, and inhibited from entering above them.

As shown in FIG. 6, the quick ON projection accommodation part 316 has left and right inner wall faces 363a and 363b with flat planes roughly parallel to each other.

The quick OFF spring accommodation part 317 has roughly the same shape as the quick ON spring accommodation part 315. The quick OFF spring accommodation part 317 has a depth d₇ greater than a diameter D₇ of the quick OFF spring 197 accommodated in the quick OFF spring accommodation part 317. The quick OFF spring accommodation part 317 has left and right inner wall faces composed of quick OFF spring accommodation inner wall faces 371a and 371b, quick OFF spring supporting inner wall faces 372a and 372b, and quick OFF projection reception inner wall faces 373a and 373b, continuously from the bottom in order. The quick OFF spring accommodation inner wall faces 371a and 371b have flat planes roughly parallel to each other. A distance w₇₁ between them is slightly greater than the diameter D₇. The quick OFF spring supporting inner wall faces 372a and 372b have recessed faces with circular column side face shapes bent along an outer periphery of the quick OFF spring 197. Diameters of them are equal to the distance w₇₁. The quick OFF projection reception inner wall faces 373a and 373b have flat planes roughly parallel to each other. A distance w₇₃ between them is less than the diameter D₇. Thereby, the quick OFF spring 197 is supported and held by the quick OFF spring supporting inner wall faces 372a and 372b, and inhibited from entering above them.

The quick ON spring accommodation part 315 has a depth d₅ roughly equal to a depth d₆ of the quick ON projection accommodation part 316, and a bottom face 354 continuously extending from a bottom face 364 of the quick ON projection accommodation part 316. The distance w₅₃ between the quick ON projection reception inner wall faces 353a and 353b is roughly equal to a width w₆ of the quick ON projection accommodation part 316. The quick ON projection reception inner wall faces 353a and 353b continuously extends from left and right inner wall faces 363a and 363b of the quick ON projection accommodation part 316. Thereby, the quick ON spring 195, accommodated in the quick ON spring accommodation part 315, is inhibited from entering into the quick ON projection accommodation part 316. The quick ON spring accommodation part 315 has a length less than a natural length of the quick ON spring 195. The quick ON spring 195 is compressed and accommodated in the quick ON spring accommodation part 315.

In the same manner, the quick OFF spring accommodation part 317 has a depth d₇ roughly equal to a depth d₈ of the quick OFF projection accommodation part 318, and a bottom face 374 continuously extending from a bottom face 384 of the quick OFF projection accommodation part 318. The distance w₇₃ between the quick OFF projection reception inner wall faces 373a and 373b is roughly equal to a width w₈ of the quick OFF projection accommodation part 318. The quick OFF projection reception inner wall faces 373a and 373b continuously extends from left and right inner wall faces 383a and 383b of the quick OFF projection accommodation part 318. Thereby, the quick OFF spring 197, accommodated in the quick OFF spring accommodation part 317, is inhibited from entering into the quick OFF projection accommodation part 318. The quick OFF spring accommodation part 317 has a length less than a natural length of the quick OFF spring 197. The quick OFF spring 197 is compressed and accommodated in the quick OFF spring accommodation part 317.

As shown in FIG. 7, the actuator 16 includes the followings.
(1) A quick ON projection 616. It is a protrusion with a roughly rectangular parallelepiped shape, protruding upward from an upper face of the actuator body 61, and accommodated in the quick ON projection accommodation part 316 of the plunger 13. The quick ON projection 616 has a length in ±A directions less than a length in ±A directions of the quick ON projection accommodation part 316. Since the plunger 13 has the quick ON spring accommodation part 315 communicating in −A direction with the quick ON projection accommodation part 316, the quick ON projection 616 enters into the quick ON spring accommodation part 315 when the actuator 16 relatively moves to −A direction against the plunger 13. This makes the quick ON projection 616 biased by the quick ON spring 195, accommodated in the quick ON spring accommodation part 315, toward +A direction against the plunger 13. In contrast, when the actuator 16 relatively moves to +A direction against the plunger 13, the quick ON projection 616 touches an inner wall face in +A direction of the quick ON projection accommodation part 316. This blocks the actuator 16 from further moving toward +A direction against the plunger 13.
(2) A quick ON spring supporting part 615. It is a protrusion protruding upward from the upper face of the actuator body 61, disposed in −A direction against the quick ON projection 616 linked with it. It supports from beneath the quick ON spring 195 accommodated in the quick ON spring accommodation part 315 of the plunger 13.
(3) A quick OFF projection 618. It is a protrusion with a roughly rectangular parallelepiped shape, protruding upward from the upper face of the actuator body 61, and accommodated in the quick OFF projection accommodation part 318 of the plunger 13. The quick OFF projection 618 has a length in ±A directions less than a length in ±A directions of the quick OFF projection accommodation part 318. Since the plunger 13 has the quick OFF spring accommodation part 317 communicating in +A direction with the quick OFF projection accommodation part 318, the quick OFF projection 618 enters into the quick OFF spring accommodation part 317 when the actuator 16 relatively moves to +A direction against the plunger 13. This makes the quick OFF projection 618 biased by the quick OFF spring 197 accommodated in the quick OFF spring accommodation part 317 toward −A direction against the plunger 13. In contrast, when the actuator 16 relatively moves to −A direction against the plunger 13, the quick OFF projection 618 touches an inner wall face in −A direction of the quick OFF projection accommodation part 318. This blocks the actuator 16 from further moving toward −A direction against the plunger 13.
(4) A quick OFF spring supporting part 617. It is a protrusion protruding upward from the upper face of the actuator body 61, and disposed in +A direction against the quick OFF projection 618 linked with it. It supports from beneath the quick OFF spring 197 accommodated in the quick OFF spring accommodation part 317 of the plunger 13.
(5) Engagement openings 621a and 621b. Each of them is an opening with a roughly rectangular shapes, disposed through the actuator upper part 62a or 62b at its rough center. They engage with the engagement protrusions 311a and 311b of the plunger 13. The engagement openings 621a and 621b have heights in a vertical direction slightly greater than heights in the vertical direction of the engagement protrusions 311a and 311b. The engagement openings 621a and 621b have widths in ±A directions greater than widths in ±A directions of the engagement protrusions 311a and 311b, so as to allow the actuator 16 to move in ±A directions against the plunger 13.
(6) Guide projection strips 622a to 622d. Each of them is a linear protrusion roughly parallel to ±A directions, protruding outward from the actuator upper parts 62a or 62b. They engage with the guide grooves 251b, 251d and 252b of the case 12, so as to guide movement of the actuator 16 in ±A directions. The guide projection strip 622a is disposed on a left side face of the actuator upper part 62a at its upper end, and engages with the guide groove 252b. The guide projection strip 622b is disposed on a right side face of the actuator upper part 62b at its upper end, and engages with the guide groove 251b. The guide projection strips 622c and 622d are linearly disposed on a right side face of the actuator upper part 62b at its rough middle, and engage with the guide groove 251d. In the cover 122, no groove is formed corresponding to the guide groove 251d. So, in assembling the trigger switch 10, erroneous attempt to inversely mount the actuator 16 causes interference of the guide projection strips 622c and 622d with the cover 122, and thereby the attempt fails. This enable to prevent misassembling.

It is noted that left and right ends of the actuator body 61 engage with the guide grooves 251c and 252c of the case 12.
(7) A slide accommodation part 631. It is a penetrating hole with a roughly rectangular shape, provided through the actuator plate 63 near its upper end. The sliding part 64 is press-fitted and fixed to it.
(8) Engagement parts 632a and 632b. Each of them is a concavity recessed from a left side face of the actuator plate 63 toward the right direction, adjacently communicating with the slide accommodation part 631 below it. They engage with engagement parts 642a and 642b, shown in FIG. 8, of the sliding part 64.
(9) Engagement parts 633a and 633b. Each of them is a concavity recessed from a right side face of the actuator plate 63 toward the left direction, adjacently communicating with the slide accommodation part 631 in ±A directions against it. They engage with press fit projections 643a and 643b, shown in FIG. 8, of the sliding part 64.
(10) A penetrating hole 635. It is a hole with roughly rectangular shape, penetrating in the left and right directions through the actuator plate 63 relatively near its lower side. The movable contact 18 is inserted through it. The penetrating hole 635 has a width in ±A directions greater than a height in a vertical direction.
(11) A holding spring accommodation part 636. It adjacently communicates with the penetrating hole 635 in −A direction against it. It accommodates the holding spring 193 of the quick movement mechanism 19. The movable contact 18 inserted through the penetrating hole 635 is biased toward +A direction against the actuator 16 by the holding spring 193 accommodated in the holding spring accommodation part 636. And,
(12) a ridge part 637. It is a protrusion with a circular column's side face shape, extending along the vertical direction, and swollen toward −A direction from an inner wall face in +A direction of the penetrating hole 635. It receives the movable contact 18 biased toward +A direction by the holding spring 193 in front of the holding spring 193 in +A direction.

As shown in FIG. 8, the sliding part 64 includes the followings.
(1) Hill parts 641a and 641b. Each of them is a protrusion swollen toward a left or right direction from a body of the sliding part 64, extending along the vertical direction. They touch the actuator tips 191a and 191b, shown in FIG. 9, of the quick movement mechanism 19, so as to restrict movement in ±A direction of the actuator 16. Preferably, the sliding part 64 is made of materials with high abrasion resistance in order to restrain abrasion of the hill parts 641a and 641b.
(2) Engagement parts 642a and 642b. Each of them is a protrusion protruding downward from the body of the sliding part 64 relatively near its left side. They engage with the engagement parts 632a and 632b of the actuator plate 63. In press-fitting of the sliding part 64 into the slide accommodation part 631, erroneous attempt to mount the sliding part 64 inversely or upside down causes interference of the engagement parts 642a and 642b, and thereby the attempt fails. This enables to prevent misassembling.
(3) Press fit projections 643a and 643b. Each of them is a protrusion protruding toward ±A directions from the body of the sliding part 64 relatively near its right side. They engage with the engagement part 633a and 633b of the actuator plate 63. The whole span in ±A direction of the sliding part 64 including the press fit projections 643a and 643b is slightly greater than a length in ±A directions of the slide accommodation part 631. When the sliding part 64 is press-fitted into the slide accommodation part 631, the sliding part 64 is inserted into the slide accommodation part 631 from its left side. Although the press fit projections 643a and 643b interfere the inner wall face of the slide accommodation part 631, the press fit projections 643a and 643b are forced to pass through it, and finally to engage with the engagement parts 633a and 633b, which are provided on the right side of the slide accommodation part 631. This enables to firmly fix the sliding part 64 to the actuator plate 63. It should be noted that the sliding part 64 may be not separately formed. It may be integrally formed with the actuator plate 63.

FIG. 9 shows the actuator tip 191a. The actuator tip 191b has the same shape. The actuator tip 191a includes the followings.
(1) A base 911. It has a roughly rectangular plate shape, a length in ±A directions slightly less than a distance between the actuator tip supporting parts 232a and 232b of the case 12, and a width in the vertical direction slightly less than a height in the vertical direction of the actuator tip supporting parts 232a and 232b. The shape of the base 911, different from a circular shape, prevents rotation of the base 911.
(2) An engagement projection 913. It is a protrusion with a roughly semi-circular column shape, protruding from a center of the base 911. It touches the hill part 641a of the sliding part 64, so as to restrict movement in ±A directions of the actuator 16. The semi-circular column shape of the engagement projection 913, different from a hemisphere shape, makes it touch the hill part 641a within a linear shape area. This reduces abrasion of the engagement projection 913. Preferably, the actuator tip 191a is made of materials with high abrasion resistance in order to further reduce abrasion of the engagement projection 913. However, excessive hardness of the actuator tip 191a causes abrasion of the hill part 641a of the sliding part 64, which touches the actuator tip 191a. Thus, it is important to select materials appropriate to the materials of the sliding part 64.
(3) Wings 912a and 912b. Each of them has a roughly rectangular plate shape, and extends roughly perpendicular to the base 911 from an end in ±A directions of the base 911 toward a direction opposite the engagement projection 913. The wings 912a and 912b sliding on the actuator tip supporting part 232a and 232b of the case 12 prevents lean of the engagement projection 913. And,
(4) a restriction spring supporting part 914. It is a protrusion with a roughly circular column shape, protruding from a center of the base 911 toward a direction same as that of the wings 912a and 912b. It supports the restriction spring 192a. The restriction spring 192a is held between the restriction spring supporting part 914 and the restriction spring supporting part 242 of the case 12.

The actuator tips 191a and 191b are disposed in spaces with roughly rectangular parallelepiped shape formed between the case 12 and the actuator 16. The spaces have upper boundaries defined by the actuator body 61 of the actuator 16, lower boundaries defined by the partition 22 of the case 12, boundaries in +A direction defined by the actuator tip supporting part 231b and 232b, boundaries in −A direction defined by the actuator tip supporting part 231a and 232a, and outer boundaries in left and right directions defined by the left and right side walls of the case 12. The spaces face the sliding part 64 in inner directions along the left and right directions. The actuator tips 191a and 191b are allowed to move in the spaces toward the left and right directions, roughly perpendicular to the ±A directions, and biased inward by the restriction springs 192a and 192b. In the actuator tips 191a and 191b, the engagement projection 913 touching the hill parts 641a and 641b of the sliding part 64 restricts movement in ±A directions of the actuator 16. In other words, the actuator tips 191a and 191b, restriction springs 192a and 192b, and sliding part 64 function as a restriction mechanism for restricting movement in ±A directions of the actuator 16.

As shown in FIG. 10, the quick ON spring supporting part 615 has an upper face 651 being a recessed face with a circular column's side face shape curved along an outer periphery of the quick ON spring 195. This enables to securely support the quick ON spring 195 accommodated in the quick ON spring accommodation part 315.

In the same manner, the quick OFF spring supporting part 617 has an upper face 671 being a recessed face with a circular column's side face shape curved along an outer periphery of the quick OFF spring 197. This enables to securely support the quick OFF spring 197 accommodated in the quick OFF spring accommodation part 317.

The quick ON projection 616 has a height h₆ roughly equal to a depth d₅, shown in FIG. 5, of the quick ON spring accommodation part 315 and a depth d₆, shown in FIG. 6, of the quick ON projection accommodation part 316, and greater than a diameter D₅, shown in FIG. 5, of the quick ON spring 195. Thereby, an end face in −A direction of the quick ON projection 616 abuts an annular end in +A direction of the quick ON spring 195 at two areas. One of the areas contains a top part of the annular end of the quick ON spring 195, and the other contains a bottom part of that. This enables the quick ON projection 616 to receive straight a biasing force toward +A direction by the quick ON spring 195.

In the same manner, the quick OFF projection 618 has a height h₈ roughly equal to a depth d₇, shown in FIG. 6, of the quick OFF spring accommodation part 317 and a depth d₈, shown in FIG. 5, of the quick OFF projection accommodation part 318, and greater than a diameter D₇, shown in FIG. 6, of the quick OFF spring 197. Thereby, an end face in +A direction of the quick OFF projection 618 abuts an annular end in −A direction of the quick OFF spring 197 at two areas. One of the areas contains a top part of the annular end of the quick OFF spring 197, and the other contains a bottom part of that. This enables the quick OFF projection 618 to receive straight a biasing force toward −A direction by the quick OFF spring 197.

As shown in FIG. 11, the ridge part 637 has a curved face shape with a round top. The movable contact 18 biased toward +A direction by the holding spring 193 touches the ridge part 637 in front of the holding spring 193. Thus, an axis around which the movable contact 18 swings in ±B directions is always in front of the holding spring 193.

It is important that the central axis of swing of the movable contact 18 is in front of the holding spring 193. The shape of the ridge part 637 is not important. It is not limited to C-shape. It may be a bent face shape with a sharp top, such as V-shape, or other shapes. The configure to locate the central axis of swing of the movable contact 18 in front of the holding spring 193 is not limited to providing the ridge part 637 on the inner wall face in +A direction of the penetrating hole 635. For example, it may be providing a ridge part on a face in +A direction of the movable contact 18.

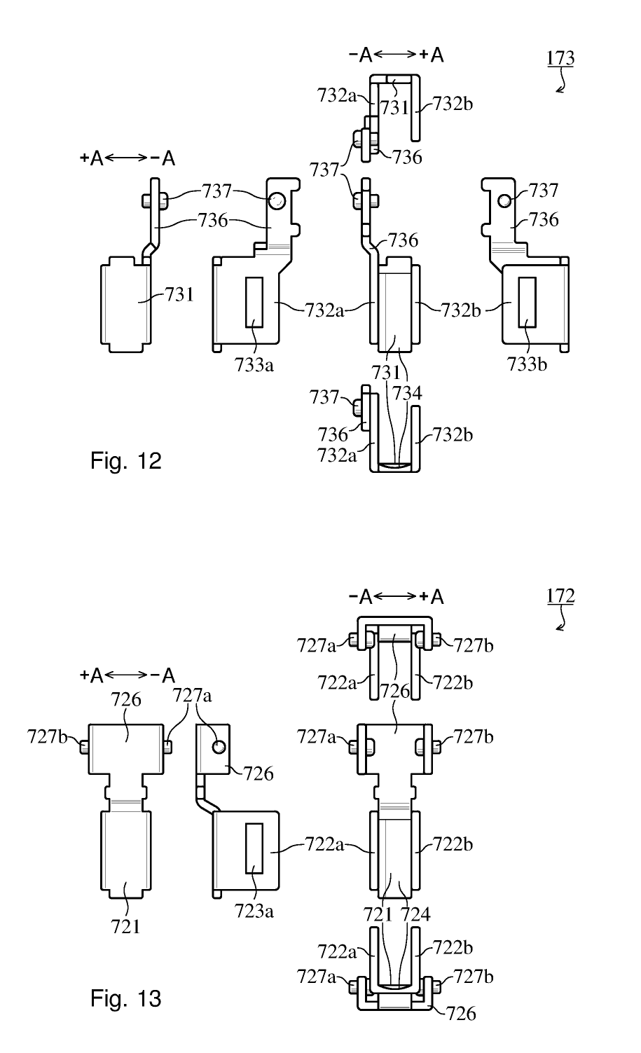

FIG. 12 shows the ON terminal 173. The OFF terminal 171 has a mirror image shape of the ON terminal 173, and will be explained with explanation of the ON terminal 173 simultaneously. In the explanation below, description about the OFF terminal 171 will be enclosed by square brackets (“[ ]”). The ON terminal 173 [the OFF terminal 171] is formed of conductor such as metal, and includes the followings.
(1) A base 731 [711]. It has a roughly rectangular plate shape, and touches a wire to be connected to the ON terminal 173 [the OFF terminal 171] so as to be electrically connected with it. It includes a recess 734 [714] on a part touching the wire. This enhances touching surface with the wire, so as to make contact resistance small.
(2) Wings 732a and 732b [712a and 712b]. Each of them has a roughly rectangular plate shape, and continuously extends roughly perpendicular to the base 731 [711] from an end in ±A directions of the base 731 [711]. They include engagement openings 733a and 733b [713a and 713b] with roughly rectangular shapes. And,
(3) a fixed contact 736 [716]. It has a plate shape continuously extending upward from an upper end of the wing 732a in −A direction [the wing 712b in +A direction]. It winds along the passage 215 of the case 12. It has a contact 737 [717] near its upper end. The contact 737 [717] is formed of materials with low contact resistance and excellent abrasion resistance, and touches the movable contact 18 so as to be electrically connected with it.

As shown in FIG. 13, the common terminal 172, formed of conductor such as metal, includes the followings.
(1) A base 721. It has a roughly rectangular plate shape, and touches a wire to be connected to the common terminal 172 so as to be electrically connected with it. It includes a recess 724 on a part touching the wire. This enhances touching surface with the wire, so as to make contact resistance small.
(2) Wings 722a and 722b. Each of them has a roughly rectangular plate shape continuously extending roughly perpendicular to the base 721 from ends in ±A directions of the base 721. They have engagement openings 723a and 723b with roughly rectangular shapes. And,
(3) a fixed contact 726. It has a plate shape continuously extending upward from an upper end of the base 721. It winds along the passage 214 of the case 12. It has an upper end branching toward ±A directions. Each branch has a contact 727a or 727b near its distal end. The contact 727a and 727b is formed of materials with low contact resistance and excellent abrasion resistance, and touches the movable contact 18 so as to be electrically connected with it.

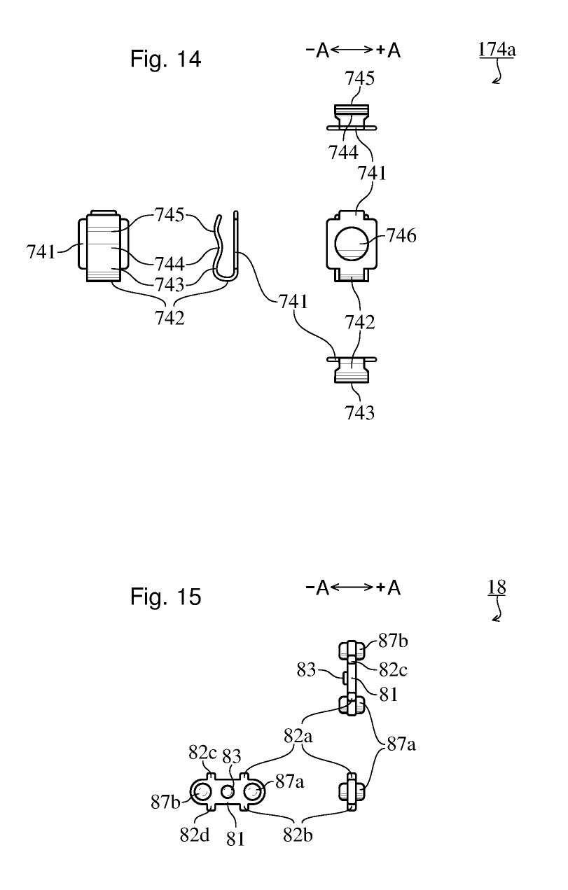

FIG. 14 shows the connection metal 174a. The connection metals 174b and 174c has the same shape. The connection metal 174a includes the followings.
(1) A engagement part 741. It has a roughly rectangular plate shape, and engages with the engagement openings 713a and 713b of the OFF terminal 171. It has a screw insertion hole 746 at its rough center. Through the screw insertion hole 746, A distal end of the connection screw 175a, shown in FIG. 1, screwed to the case 12 is inserted.
(2) A bend 742. It continuously extends downward from the engagement part 741. It is bent like U-shape, and points upward at its distal end.
(3) A pressing hill part 743. It continuously extends upward from the distal end of the bend 742, and curves swollen toward the left side. It presses the wire connected to the OFF terminal 171, so as to prevent disconnection of the wire.
(4) A valley part 744. It continuously extends upward from a distal end of the pressing hill part 743, and curves swollen toward the right side. It is pressed by a distal end of the connection screw inserted through the screw insertion hole 746. And,
(5) a pressing hill part 745. It continuously extends upward from a distal end of the valley part 744, and curves swollen toward the left side. It presses the wire connected to the OFF terminal 171, so as to prevent disconnection of the wire. The swelling of the pressing hill part 745 is smaller than that of the pressing hill part 743.

The force applied to the valley part 744 by the connection screw 175a is deployed to the two pressing hill parts 743 and 745. The pressing hill parts 745 is a free end, while the pressing hill parts 743 is connected to the bend 742. Thus, the pressing hill parts 745 moves longer than the pressing hill parts 743 does. When it is pressed by the connection screw 175a, the difference of sizes of the swellings cancels out the difference of the movement, so that a distance between a top of the pressing hill parts 745 and the base 711 of the OFF terminal 171 becomes roughly equal to a distance between a top of the pressing hill parts 743 and the base 711 of the OFF terminal 171. This enables to roughly equalize pressing forces applied by the two pressing hill parts 743 and 745 to the wire inserted between the OFF terminal 171 and the connection metal 174a, and thereby to securely prevent disconnection of the wire.

As shown in FIG. 15, the movable contact 18, formed of conductor such as metal, includes the followings.
(1) A base 81. It has an oblong and flat plate shape, and a width in the vertical direction slightly less than a height in the vertical direction of penetrating hole 635 of the actuator plate 63.
(2) Engagement projections 82a to 82d. Each of them is a projection protruding outward in the vertical direction from an upper or lower edge of the base 81. A distance between the two engagement projections 82a and 82c, and a distance between the two engagement projections 82b and 82d are slightly greater than a thickness in the left and right directions of the actuator plate 63 of the plunger 13. A whole width in the vertical direction of the movable contact 18 including the engagement projections 82a to 82d is greater than a height in the vertical direction of the penetrating hole 635 of the actuator plate 63, but less than a width in ±A directions of the penetrating hole 635. Laying down the movable contact 18 enables the movable contact 18 to be inserted into the penetrating hole 635. Then standing up the movable contact 18 inserted into the penetrating hole 635 makes the actuator plate 63 held between the engagement projections 82a to 82d, so as to prevent the movable contact 18 from slipping toward the left or right direction.
(3) A holding spring supporting part 83. It is a protrusion protruding toward −A direction from a rough center of a face in −A direction of the base 81. It engages with an end in +A direction of the holding spring 193, so as to support the holding spring 193. And,
(4) contacts 87a and 87b. Each of them is disposed near a left or right end of the base 81. It is formed of materials with low contact resistance and excellent abrasion resistance. It touches the contact 717 of the OFF terminal 171, the contacts 727a and 727b of the common terminal 172, and the contact 737 of the ON terminal 173, so as to be electrically connected to them.

Next, behavior of the trigger switch 10 will be explained with FIG. 16. In FIG. 16, the top row shows positional relation of the case 12, the plunger 13 and the actuator 16. The middle row shows positional relation of the sliding part 64 and the actuator tips 191a and 191b. The bottom row shows positional relation of the movable contact 18, the OFF terminal 171, the common terminal 172 and the ON terminal 173. The left column shows an OFF state. The right column shows an ON state.

### <OFF State: When the User of the Electric Power Tool Releases the Trigger>

The plunger 13 is biased toward −A direction by the return spring 14, so as to be held against the inner wall in −A direction of the case 12.

The actuator 16 is located relatively nearer to +A direction against the plunger 13. The quick OFF projection 618 partially enters the quick OFF spring accommodation part 317, so as to be biased toward −A direction by the quick OFF spring 197. The quick ON projection 616 is located in the quick ON projection accommodation part 316. The quick ON spring 195 cannot enter the quick ON projection accommodation part 316. So, a biasing force of the quick ON spring 195 is not applied to the quick ON projection 616. Thereby, the whole of the actuator 16 is biased toward −A direction.

In this state, the hill parts 641a and 641b of the sliding part 64 are located nearer to −A direction than the engagement projections 913 of the actuator tips 191a and 191b are.

The movable contact 18 abuts the ridge part 637 of the actuator plate 63. Since the actuator 16 is biased toward −A direction, the movable contact 18 is also biased toward −A direction. The contact 87a is held against the contact 717 of the OFF terminal 171. The contact 87b is held against the contact 727a of the common terminal 172. Thereby, the movable contact 18 touches the fixed contact 716 of the OFF terminal 171 and the fixed contact 726 of the common terminal 172, so as to be electrically connected to them, and to bridge the fixed contacts 716 and 726 (OFF fixed contacts).

The contact room 282, shown in FIG. 3, includes a movable contact room 283 therein surrounded by the fixed contacts 716, 726 and 736. The movable contact 18 moves in the movable contact room 283. All areas where the movable contact 18 and the fixed contact 716, 726 and 736 touch each other are in the movable contact room 283.

The OFF state is a state where the actuator 16 is located the nearest to −A direction against the case 12. An end in +A direction of the actuator plate 63 does not enter the movable contact room 283. Thus, the actuator plate 63 always exists between the fixed contacts 726 and 736, which define the movable contact room 283 in +A direction, so as not to widely open between them. Thereby, in rare case that dust, water or the like invade the case 12, they are prevented from invading the movable contact room 283. This enables to prevent occurrence of poor contacting.

### <OFF State to Transition State: When the User Pulls the Trigger a Little>

The plunger 13 slightly moves toward +A direction with overcoming the biasing force applied by the return spring 14.

The movement of the plunger 13 toward +A direction causes the actuator 16 to relatively move toward −A direction against the plunger 13. The quick OFF projection 618 leaves the quick OFF spring accommodation part 317, so as to be released from the biasing force applied by the quick OFF spring 197, because the quick OFF spring 197 cannot enter the quick OFF projection accommodation part 318. In contrast, the quick ON projection 616 partially enter the quick ON spring accommodation part 315, so as to be biased toward +A direction by the quick ON spring 195. Thereby, the whole of the actuator 16 is biased toward +A direction.

However, the location of the hill parts 641a and 641b of the sliding part 64 nearer to −A direction than that of the engagement projection 913 of the actuator tips 191a and 191b causes slopes in +A direction of the hill parts 641a and 641b to abut the engagement projection 913. The actuator tips 191a and 191b being biased inward by the restriction spring 192a and 192b blocks movement in +A direction of the actuator 16. This makes the movement toward +A direction of the actuator 16 smaller than the movement toward +A direction of the plunger 13. The actuator 16 relatively moves toward −A direction against the plunger 13, so as to compress the quick ON spring 195 and to accumulate energy in it. The movement toward +A direction of the actuator 16 results in the movable contact 18 leaving the OFF position toward +A direction. The contact 87a is parted from the contact 717 of the OFF terminal 171, and the contact 87b is parted from the contact 727a of the common terminal 172. This removes the bridging between the fixed contact 716 and 726. Moving velocity of the movable contact 18 is relatively slow in this time. However, no arc occurs, since no electric current flows via the movable contact 18.

### <Transition State to ON State: When the User Further Pulls the Trigger>

The plunger 13 further moves toward +A direction.

The actuator 16 also further moves toward +A direction. However, the movement smaller than that of the plunger 13 causes relative movement toward −A direction against the plunger 13. When an end in −A direction of the quick OFF projection 618 abuts an inner wall in −A direction of the quick OFF projection accommodation part 318, the actuator 16 cannot relatively move further toward −A direction against the plunger 13, so as to be forced to move toward +A direction.

When the hill parts 641a and 641b of the sliding part 64 pass over a position of the engagement projection 913, obstruction against movement of the actuator 16 is disappeared. Energy accumulated in the quick ON spring 195 forces the actuator 16 to rapidly move toward +A direction.

The movable contact 18, with biased by the holding spring 193 to be held against the ridge part 637, moves toward +A direction along with the actuator 16. This causes the contact 87a to abut the contact 737 of the ON terminal 173, and the contact 87b to abut the contact 727b of the common terminal 172.

Thereby, the movable contact 18 touches the fixed contact 736 of the ON terminal 173 and the fixed contact 726 of the common terminal 172 so as to be electrically connected to them, and thereby bridging between the fixed contacts 736 and 726 (ON fixed contacts). This realizes connection between electric power source and the motor of the electric power tool, and rotation of the motor.

After the movable contact 18 reaches the ON position to bridge between the fixed contacts 736 and 726, the actuator 16 still moves toward +A direction. The movable contact 18 is parted from the ridge part 637, and relatively moves toward −A direction against the actuator 16. The holding spring 193 biases the movable contact 18 toward +A direction, so as to press the contact 87a against the contact 737, and to press the contact 87b against the contact 727b. This enables to prevent rebounding and thereby separation of the movable contact 18 from the fixed contact 736 and 726 after electric current starts flowing via the movable contact 18. This achieves prevention of arc.

The ON state is a state where the actuator 16 is located the nearest to +A direction against the case 12. An end in −A direction of the actuator plate 63 does not enter the movable contact room 283. Thus, the actuator plate 63 always exists between the fixed contacts 716 and 726, which defines the movable contact room 283 in −A direction, so as not to widely open between them. Thereby, in rare case that dust, water or the like invade the case 12, they are prevented from invading the movable contact room 283. This enables to prevent occurrence of poor contacting.

### <ON State: When the User Slightly Weakens the Force for Pulling the Trigger>

The plunger 13 is biased by the return spring 14, so as to slightly move toward −A direction. The movement of the plunger 13 toward −A direction causes the actuator 16 to relatively move toward +A direction against the plunger 13. The quick ON projection 616 locates in the quick ON projection accommodation part 316, so as not to be applied biasing force from the quick ON spring 195. The quick OFF projection 618 partially enter the quick OFF spring accommodation part 317, so as to be biased toward −A direction by the quick OFF spring 197. Thereby, the whole of the actuator 16 is biased toward −A direction.

However, the location of the hill parts 641a and 641b of the sliding part 64 nearer to +A direction than that of the engagement projection 913 of the actuator tips 191a and 191b causes slopes in −A direction of the hill parts 641a and 641b to abut the engagement projection 913. The actuator tips 191a and 191b being biased inward by the restriction spring 192a and 192b blocks movement in −A direction of the actuator 16. This makes the movement toward −A direction of the actuator 16 smaller than the movement toward −A direction of the plunger 13. The actuator 16 relatively moves toward +A direction against the plunger 13, so as to compress the quick OFF spring 197 and to accumulate energy in it.

The movable contact 18 is biased toward +A direction by the holding spring 193, so as not to leave the ON position while the actuator 16 moves toward −A direction. This keeps the movable contact 18 bridging between the fixed contacts 736 and 726.

### <ON State to OFF State: When the User Further Weakens the Force for Pulling the Trigger>

The plunger 13 further moves toward −A direction.

The actuator 16 also further moves toward −A direction. However, the movement smaller than that of he plunger 13 causes relative movement toward +A direction against the plunger 13. When an end in +A direction of the quick ON projection 616 abuts an inner wall in +A direction of the quick ON projection accommodation part 316, the actuator 16 cannot relatively move further toward +A direction against the plunger 13, so as to be forced to move toward −A direction.

When the hill parts 641a and 641b of the sliding part 64 pass over a position of the engagement projection 913, obstruction against movement of the actuator 16 is disappeared. Energy accumulated in the quick OFF spring 197 forces the actuator 16 to rapidly move toward −A direction.

When the movement of the actuator 16 results in the ridge part 637 abutting the movable contact 18, the movable contact 18 cannot further relatively move toward +A direction against the actuator 16, so as to be forced to move toward −A direction. The contact 87a is parted from the contact 737 of the ON terminal 173, and the contact 87b is parted from the contact 727b of the common terminal 172. This removes the bridging between the fixed contacts 736 and 726. Moving velocity of the movable contact 18 in this time is the same as that of the actuator 16. The movable contact 18 is rapidly separated from the fixed contact 736 and 726, so as to prevent arc.

After the movable contact 18 is parted from the fixed contacts 736 and 726, the actuator 16 keeps the rapid movement toward −A direction. The movable contact 18 also keeps the movement along with the actuator 16. Finally, the contact 87a abuts the contact 717 of the OFF terminal 171, and the contact 87b abuts the contact 727a of the common terminal 172. Thereby, the movable contact 18 touches the fixed contact 716 of the OFF terminal 171 and the fixed contact 726 of the common terminal 172, so as to be electrically connected to them, and thereby to bridge between the fixed contacts 716 and 726. The bridging between the fixed contacts 716 and 726 allows regeneration current to flow via the movable contact 18, so as to brake the motor keeping rotation caused by inertia. This achieves quick stop of the rotation of the motor.

If rebounding occurs in a short period before the motor stops, the touching between the movable contact 18 and the fixed contacts 716 and 726 is lost. This may cause arc because electric current is flowing via the movable contact 18. However, the central axis of swing of the movable contact 18 disposed in front of the holding spring 193 enables to prevent rebounding with no spring for biasing the movable contact 18 toward −A direction. The principle will be explained below.

Some factors such as processing accuracy of parts hinder complete elimination of difference between positions in ±A directions of the contacts 717 and 727a. Thus, the movable contact 18 in the OFF state is not completely perpendicular to ±A directions, but slightly leans.

As shown in a left side of FIG. 17 for comparison, an actuator plate 63′ includes an penetrating hole 635 having an inner wall in +A direction with a flat plane shape and no ridge part 637.

It is assumed that the contact 717 is located in +A direction in comparison with the contact 727a. When the movable contact 18 arrives, the contact 87a touches the contact 717 before the contact 87b touches the contact 727a. The movable contact 18 receives force toward +A direction from the contact 717 and force toward −A direction from the actuator plate 63. This causes the movable contact 18 swing toward −B direction. Then, the contact 87b touches the contact 727a, so that the fixed contacts 716 and 726 are bridged.

However, lean of the movable contact 18 causes an edge line, which is a boundary between the inner wall in +A direction of the penetrating hole 635 and a surface of the actuator plate 63 at a side of the contact 717, to function as a fulcrum of the swinging of the movable contact 18. The movable contact 18 receives a force toward +A direction from the holding spring 193, and there is a gap between the movable contact 18 and the actuator plate 63 in front of the holding spring 193. This may cause arc because the movable contact 18 swings toward +B direction so as to temporarily lose touching between the contact 87b and 727a.

In contrast, the actuator plate 63 according to the present embodiment is provided with the ridge part 637 on the inner wall in +A direction of the penetrating hole 635, as shown in a right side of FIG. 17. Thereby, the ridge part 637 functions as the fulcrum of the swinging of the movable contact 18. The axis of swinging located in front of the holding spring 193 prevents the lean of the movable contact 18 from generating a gap in front of the holding spring 193. Thus, the movable contact 18 does not swing even when it receives the force toward +A direction from the holding spring 193. This achieves prevention of rebounding and arc.

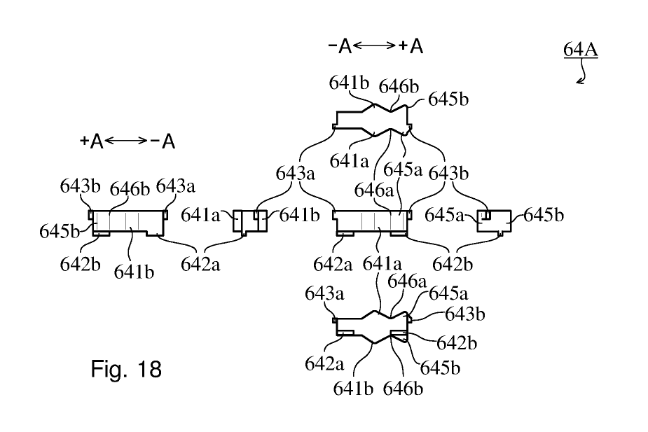

A sliding part 64A shown in FIG. 18 may be used in the trigger switch 10, instead of the sliding part 64 described above. The sliding part 64A further includes hill parts 645a and 645b in +A direction against the hill parts 641a and 641b. Thereby, valley parts 646a and 646b are formed between the hill parts 645a and 645b and the hill parts 641a and 641b. Positions of the valley parts 646a and 646b roughly coincide with positions where the actuator tips 191a and 191b abut the sliding part 64A in OFF state.

In transition from ON state to OFF state, the actuator 16 rapidly moves toward −A direction. Simultaneously, the positions where the actuator tips 191a and 191b abut the sliding part 64A relatively move toward +A direction against the sliding part 64A. While the contacts 87a and 87b of the movable contact 18 touch the contact 717 of the OFF terminal 171 and the contact 727a of the common terminal 172, the positions where the actuator tips 191a and 191b abut the sliding part 64A pass over the valley part 646a and 646b at roughly the same time. Then, the actuator tips 191a and 191b abut the hill part 645a and 645b, so as to brake the movement toward −A direction of the sliding part 64A.

This diminishes momentum when the contacts 87a and 87b touch the contacts 717 and 727a. This enhances effect of restraining rebounding of the movable contact 18 and prevention of arc.

It should be noted that the positions of the valley part 646a and 646b may not be the positions where the actuator tips 191a and 191b abut the sliding part 64A in OFF state. It may be slightly in +A direction against the positions. This enables to brake the movement toward −A direction of the sliding part 64A before the contacts 87a and 87b touch the contacts 717 and 727a. This achieves more diminishment of the momentum when the contacts 87a and 87b touch the contacts 717 and 727a, and thereby more enhancement of the effect of restraining rebounding of the movable contact 18 and prevention of arc.

The above described embodiments are examples to make it easier to understand the present invention. The present invention is not limited to the example, and includes any modified, altered, added, or removed variations, without departing from the scope of the claims attached herewith. This can be easily understood by persons skilled in the art.

### REFERENCE SIGNS LIST

10: trigger switch; 12: case; 121: case body; 122: cover; 13: plunger; 14: return spring; 15: dustproof mechanism; 151: packing; 152: sponge; 16: actuator; 17: terminal part; 171: OFF terminal; 172: common terminal; 173: ON terminal; 174a to 174c: connection metal; 175a to 175c: connection screw; 18: movable contact; 19: quick movement mechanism; 191a and 191b: actuator tip; 192a and 192b: restriction spring; 193: holding spring; 195: quick ON spring; 197: quick OFF spring; 21 and 22: partition; 211, 212, 221 and 222: partition part; 213 to 215: passage; 231a, 231b, 232a and 232b: actuator tip supporting part; 241, 242 and 914 restriction spring supporting part; 251a to 251d and 252a to 252c: guide groove; 28: switch room; 281 plunger room; 282 contact room; 283; movable contact room; 29: wire room; 31: plunger body; 311a and 311b: engagement protrusion; 312: return spring accommodation part; 313a to 313c: slide projection strip; 314a to 314d: guide wing; 315: quick ON spring accommodation part; 316: quick ON projection accommodation part; 317: quick OFF spring accommodation part; 318: quick OFF projection accommodation part; 32: operation part; 351a and 351b: quick ON spring accommodation inner wall face; 352a and 352b: quick ON spring supporting inner wall face; 353a and 353b: quick ON projection reception inner wall face; 354, 364, 374 and 384: bottom face; 363a, 363b, 383a and 383b: inner wall face; 371a and 371b: quick OFF spring accommodation inner wall face; 372a and 372b: quick OFF spring supporting inner wall face; 373a and 373b: quick OFF projection reception inner wall face; 61: actuator body; 615: quick ON spring supporting part; 616: quick ON projection; 617: quick OFF spring supporting part; 618: quick OFF projection; 62a and 62b: actuator upper part; 621a, 621b, 713a, 713b, 723a, 723b, 733a and 733b: engagement opening; 622a to 622d: guide projection strip; 63 actuator plate; 631: slide accommodation part; 632a, 632b, 633a, 633b, 642a, 642b and 741: engagement part; 635: penetrating hole; 636: holding spring accommodation part; 637: ridge part; 64 and 64A: sliding part; 641a, 641b, 645a and 645b: hill part; 643a and 643b press fit projection; 646a, 646b and 744: valley part; 651 and 671: upper face; 711, 721, 731, 81 and 911: base; 712a, 712b, 722a, 722b, 732a, 732b, 912a and 912b: wing; 714, 724 and 734: recess; 716, 726 and 736: fixed contact; 717, 727a, 727b, 737, 87a and 87b: contact; 742: bend; 743 and 745: pressing hill part; 746: screw insertion hole; 82a to 82d and 913: engagement projection; and 83: holding spring supporting part.

1. A switch, comprising:
an actuator, allowed to move toward an ON direction and toward an OFF direction opposite the ON direction;
a movable contact, engaging with the actuator;
a fixed contact, configured to touch the movable contact with electrical connection when the movable contact is located at an ON position, and to be apart from the movable contact with electrical isolation when the movable contact is located at positions other than the ON position; and
an arc prevention mechanism, configured to prevent generation of arc between the movable contact and the fixed contact.

2. The switch of claim 1, further comprising
a plunger, allowed to move toward the ON direction and toward the OFF direction,
wherein the actuator engages with the plunger to be allowed to move toward the ON direction and toward the OFF direction against the plunger,
the arc prevention mechanism comprises:
a quick ON spring, composed of a helical compression spring to bias the actuator toward the ON direction against the plunger;
a quick OFF spring, composed of a helical compression spring to bias the actuator toward the OFF direction against the plunger; and
a restriction mechanism, configured to restrict movement of the actuator before the actuator passes over a switching position, and to release the actuator after the actuator passes over the switching position,
the plunger comprises:
a quick ON spring accommodation part, accommodating the quick ON spring;
a quick ON projection accommodation part, disposed in the ON direction against the quick ON spring accommodation part;
a quick OFF spring accommodation part, disposed in a direction different from the ON direction and the OFF direction against the quick ON spring accommodation part, and accommodating the quick OFF spring; and
a quick OFF projection accommodation part, disposed in the OFF direction against the quick OFF spring accommodation part, and
the actuator comprises:
a quick ON projection, accommodated in the quick ON projection accommodation part with being allowed to move toward the ON direction and the OFF direction, and biased toward the ON direction by the quick ON spring; and
a quick OFF projection, accommodated in the quick OFF projection accommodation part with being allowed to move toward the ON direction and the OFF direction, and biased toward the OFF direction by the quick OFF spring.

3. The switch of claim 2,
wherein the quick ON projection is a protrusion protruding toward a direction different from the ON direction and the OFF direction, and has a roughly rectangular parallelepiped shape, a width smaller than a diameter of the quick ON spring, and a height larger than the diameter of the quick ON spring,
the quick OFF projection is a protrusion protruding toward a direction different from the ON direction and the OFF direction, and has a roughly rectangular parallelepiped shape, a width smaller than a diameter of the quick OFF spring, and a height larger than the diameter of the quick OFF spring,
the quick ON projection accommodation part is a concavity with an opening in a direction opposite the direction toward which the quick ON projection protrudes, and has a width smaller than the diameter of the quick ON spring,
the quick OFF projection accommodation part is a concavity with an opening in a direction opposite the direction toward which the quick OFF projection protrudes, and has a width smaller than the diameter of the quick OFF spring,
the quick ON spring accommodation part is a concavity with an opening in a direction roughly the same as the direction of the opening of the quick ON projection accommodation part, has a depth roughly the same as that of the quick ON projection accommodation part, and comprises:
quick ON spring accommodation inner wall faces, having a distance between them roughly the same as the diameter of the quick ON spring;
quick ON spring supporting inner wall faces, continuously extending inward from the quick ON spring accommodation inner wall faces, and curving along an outer periphery of the quick ON spring with a roughly circular column shape; and
quick ON projection reception inner wall faces, continuously extending further inward from the quick ON spring accommodation inner wall faces, and having a distance between them roughly the same as the width of the quick ON projection accommodation part, and
the quick OFF spring accommodation part is a concavity with an opening in a direction roughly the same as the direction of the opening of the quick OFF projection accommodation part, has a depth roughly the same as that of the quick OFF projection accommodation part, and comprises:
quick OFF spring accommodation inner wall faces, having a distance between them roughly the same as the diameter of the quick OFF spring;
quick OFF spring supporting inner wall faces, continuously extending inward from the quick OFF spring accommodation inner wall faces, and curving along an outer periphery of the quick OFF spring with a roughly circular column shape; and
quick OFF projection reception inner wall faces, continuously extending further inward from the quick OFF spring accommodation inner wall faces, and having a distance between them roughly the same as the width of the quick OFF projection accommodation part.

4. The switch of claim 3,
wherein the actuator comprises:
a quick ON spring supporting part, being a protrusion disposed in the OFF direction against the quick ON projection, protruding toward a direction roughly the same as the direction toward which the quick ON projection protrudes, and having a width roughly the same as the width of the quick ON projection, and an upper face recessed along the outer periphery of the quick ON spring with a roughly circular cylindrical shape; and
a quick OFF spring supporting part, being a protrusion disposed in the ON direction against the quick OFF projection, protruding toward a direction roughly the same as the direction toward which the quick OFF projection protrudes, and having a width roughly the same as the width of the quick OFF projection, and an upper face recessed along the outer periphery of the quick OFF spring with a roughly circular cylindrical shape.

5. The switch of claim 1, further comprising:
a second fixed contact, configured to touch the movable contact to be electrically connected with the fixed contact via the movable contact when the movable contact is located at the ON position, and to be apart from the movable contact to be electrically isolated from the movable contact and the fixed contact when the movable contact is located at positions other than the ON position;
an OFF fixed contact, configured to touch the movable contact with electrical connection when the movable contact is located at an OFF position in the OFF direction against the ON position, and to be apart from the movable contact with electrical isolation when the movable contact is located at positions other than the OFF position; and
a second OFF fixed contact, configured to touch the movable contact to be electrically connected with the OFF fixed contact via the movable contact when the movable contact is located at the OFF position, and to be apart from the movable contact to be electrically isolated from the movable contact and the OFF fixed contact when the movable contact is located at positions other than the OFF position,
the arc prevention mechanism comprises
a holding spring, composed of a helical compression spring, biasing the movable contact toward the ON direction against the actuator, to hold the movable contact in the ON position when the actuator is located in the ON direction of the switching position,
the actuator comprises
an actuator plate, intervening between the fixed contact and the second fixed contact and between the OFF fixed contact and the second OFF fixed contact,
the actuator plate comprises:
a holding spring accommodation part, accommodating the holding spring; and
a penetrating hole, disposed in the ON direction against the holding spring accommodation part, the movable contact inserted through the penetrating hole, and
the movable contact is allowed to swing around a fulcrum in the ON direction against the holding spring when the movable contact touches an inner wall face in the ON direction of the penetrating hole by being biased by the holding spring.

6. The switch of claim 5,
wherein the penetrating hole comprises a ridge part, swollen toward the OFF direction from the inner wall face in the ON direction, and functioning as the fulcrum of the swing of the movable contact.

7. The switch of claim 5, further comprising:
a plunger, allowed to move toward the ON direction and toward the OFF direction,
wherein the actuator engages with the plunger to be allowed to move toward the ON direction and toward the OFF direction against the plunger,
the arc prevention mechanism comprises:
a quick ON spring, composed of a helical compression spring, and biasing the actuator toward the ON direction against the plunger;
a quick OFF spring, composed of a helical compression spring, and biasing the actuator toward the OFF direction against the plunger; and
a restriction mechanism, configured to restrict a movement of the actuator before the actuator passes over the switching position, and to release the actuator after the actuator passes over the switching position.

8. The switch of claim 6, further comprising:
a plunger, allowed to move toward the ON direction and toward the OFF direction,
wherein the actuator engages with the plunger to be allowed to move toward the ON direction and toward the OFF direction against the plunger,
the arc prevention mechanism comprises:
a quick ON spring, composed of a helical compression spring, and biasing the actuator toward the ON direction against the plunger;
a quick OFF spring, composed of a helical compression spring, and biasing the actuator toward the OFF direction against the plunger; and
a restriction mechanism, configured to restrict a movement of the actuator before the actuator passes over the switching position, and to release the actuator after the actuator passes over the switching position.
